(19) United States
(12) Patent Application Publication
(10) Pub. No.: US 2013/0339245 A1
(43) Pub. Date: Dec. 19, 2013

(54) Method for Performing Transaction Authorization to an Online System from an Untrusted Computer System

(71) Applicant: Jeremy Epstein, Fairfax, VA (US)

(72) Inventor: Jeremy Epstein, Fairfax, VA (US)

(73) Assignee: SRI INTERNATIONAL, Menlo Park, CA (US)

(21) Appl. No.: 13/916,346

(22) Filed: Jun. 12, 2013

Related U.S. Application Data
(60) Provisional application No. 61/659,076, filed on Jun. 13, 2012.

(51) Int. Cl. G06Q 20/40

(52) U.S. Cl. CPC G06Q 20/40145
USPC 705/44

(57) ABSTRACT

Malicious software running in personal computers manipulates victims' bank accounts without their knowledge, performing transactions without the user's approval. The result is banking fraud, both against individual consumers and organizations. Using voice technologies, we demonstrate a prototype system to validate individual banking transactions without the need for out-of-band techniques such as telephone calls.

### CROSS-REFERENCE TO RELATED APPLICATIONS

The present application claims the benefit of and priority to U.S. Provisional Application Ser. No. 61/659,076, filed Jun. 13, 2012, which is incorporated herein by this reference in its entirety.

### SUMMARY

A method for allowing users of an online system (e.g., online banking) to authorize transactions (e.g., pay bills) from untrusted computer systems is disclosed herein.

Internet users need to be able to perform business transactions such as online banking, even though the computer systems that are being used are commonly populated by malicious software that may try to perform unauthorized transactions without the user's approval.

The general approach is to have an “out of band” authentication method for the user to the system that cannot be spoofed by malicious software. The method proposed is to have the online system (generically a server) present a series of CAPTCHAs to the user through their browser, and the user speaks the selection into a microphone. CAPTCHA stand for Completely Automated Public Turing test to tell Computers and Humans Apart, which is a method for a server to present an obfuscated text image to a user, where the user (but not a computer) can easily determine what the image represents and type the text. The recording of the user is transmitted to the server, which uses it for two purposes: (1) using voice recognition, to figure out which CAPTCHA was selected to prevent against replay attacks and (2) by comparing the voice to a known sample of the user to determine that it really is the human (voice identification) and not a synthesized voice or a message pieced together from previous recordings. To avoid undue user inconvenience, the verification could be limited to just large transactions or anomalous transactions such as the first transfer to a new recipient. This relies on previously having recorded each user's voice, which is relatively feasible for a bank since they have the opportunity for face-to-face contact with their customers.

For the bank or other online system, this can reduce the incidence of fraud from malicious software. The Zeus Trojan Horse is an example of such malware—if a user's computer is compromised, it silently waits for the person to log on to their banking site, and then silently performs money transfers to accounts controlled by confederates; it then manages interactions that look at transaction histories and balances and updates them before displaying to the user, so the user can't tell that their account has been emptied. This type of attack has been a major problem in the business world—as an example, the threat to small businesses is so severe that the American Bankers Association has recommended that businesses have a dedicated computer for financial operations that is not used for web surfing, email, etc. to reduce the risk of fraud. Using a voice system such as that described above would effectively preclude attacks like those described here.

Other methods to have involved using one-time authentication tokens (such as RSA SecureID), but those have limitations, such as that the user needs to have a different authentication token for each online system (e.g., a different token for every bank they interact with), and the user must have the token any time a transaction is desired.

### BRIEF DESCRIPTION OF THE DRAWINGS

This disclosure is illustrated by way of example and not by way of limitation in the accompanying figures. The figures may, alone or in combination illustrate one or more embodiments of the disclosure. Elements illustrated in the figures are not necessarily drawn to scale. Reference labels may be repeated among the figures to indicate corresponding or analogous elements.

FIG. 1 is a flow diagram of an example of an online banking transaction involving a user entering user input such as a username, password, and transaction request (“Pay $580.00 to Camp Hackaway by Oct. 2, 2010”) to a client interface of a bank client at a user computer, and a bank server confirming the user's ID and confirming the transaction, without malware involvement;

FIG. 2 is a flow diagram representing an example of a Man in the Browser Attack on the online banking transaction of FIG. 1, in which the transaction request of FIG. 1 is modified by a Trojan horse malware program and the transaction is confirmed by the bank server, without the use of the techniques disclosed herein;

FIG. 3 is an example of a screen shot of the client interface of FIG. 1 presenting a transaction challenge to the user as disclosed herein, where the transaction challenge asks the user to record the user's voice speaking the transaction request, including financial information, and speaking a confirmation code (such as a CAPTCHA);

FIG. 4 is a flow diagram representing an example of the transaction of FIG. 1 as modified by the Man in the Browser Attack of FIG. 2 and the transaction challenge of FIG. 3, where the Man in the Browser Attack modifies the transaction request, the user speaks the transaction challenge, and the bank server uses speech recognition and speaker verification as disclosed herein to reject the transaction request as modified by the Man in the Browser Attack; and

FIG. 5 is a flow diagram of an example of a malware-created transaction authorization.

### DETAILED DESCRIPTION

A recent paper on voting technology is at http://popoveniuc.com/papers/SpeakUp.pdf.

The need is for a person to be able to vote remotely (i.e., not at a polling place) from their personal computer even in the face of malware. This leads to two requirements: (1) a server should be able to authenticate that the voter is at the computer and not malware pretending to be the voter and (2) have the ability for the voter to make a choice of candidates even in the presence of malware in a way that malware can't imitate or subvert. The approach is to have the server send a series of CAPTCHAs to the voter's computer for each candidate, and have the voter speak (into a microphone) one of the CAPTCHAs corresponding to the candidate that s/he wants, with different CAPTCHAs given to each voter. The server can then use the voter's voice to verify that s/he is who s/he says s/he is (voice identification) and figure out which of the CAPTCHA texts the voter read (speech-to-text with a limited vocabulary). Even if the voter's computer has malware that can figure out the text corresponding to the CAPTCHA, the malware can't create speech that will fool the voice identification part of the system, so at most the malware would be able to prevent the voter from selecting the candidate of choice (but not selecting an alternate candidate). For auditing purposes, the server can record the CAPTCHAs it presented to the voter along with the voter's voice speaking one of them. The benefit to the voter is that they can vote from anywhere even if the computer is malware infested (and since they're reading out codewords, not candidate names, being overheard isn't a problem). The competition is people using less secure solutions, which may lead to wholesale attacks on the voting system. Some of the E2E (end-to-end, improperly named) systems theoretically have this advantage, but they're very cumbersome for voters to use.

There's a presumption here that voters' voices are on file with the election office—but that can be resolved through a gradual migration by having voters show their ID at the polls and get their voice recorded, which can then be used in the future for online voting.

The generalization, which is the subject of the invention is that this technique could work equally well with any online transaction—why not use it for online banking? To perform a sensitive transaction, the bank customer has to follow a similar process to the above with CAPTCHAs and speech. To reduce the overhead for both the bank and the customer, you wouldn't want to do this for every transaction—maybe only transactions over a certain dollar value, or the first time a recipient is seen, and randomly (but not frequently) thereafter. For auditing purposes, the text to be spoken might be the dollar amount of the transaction and the name of the recipient along with the CAPTCHA, so the bank could prove that the person had in fact authenticated the transaction, thus reducing the risk to the bank of a customer disclaiming a transaction.

For example, if a customer asked to transfer $12.34 to ABC Cleaners, they might be provided with several CAPTCHAs with instructions indicating “say ‘orange sherbet’ to approve a transfer of $12.34 to ABC Liquors or say ‘springtime flowers’ for $12.34 to ABC Cleaners or ‘brown table’ to disapprove the transaction”.

Note that this works particularly well for bank customers who are using mobile phones, as is increasingly the case—since those by definition already have voice capabilities. You could even marry it with use of SMS in place of CAPTCHAs for sending out the strings to be read back, although that reduces the security somewhat since malware on the device could read the SMS strings and figure out which selection the customer is choosing.

This same concept can of course be used for any type of transaction, not just banking. However, banks are in a particularly good position to use this sort of technology because they have brick-and-mortar offices (in most cases, near where their customers live and/or work), and they have the motivation to get their customers to come in and give a voice sample.

There are of course privacy issues with capturing and storing voice. But it's not nearly as big an issue as other sorts of biometrics (like fingerprints), since the usage is such that simply playing back the customer's voice won't do any good, unless you have them recording the whole dictionary.

A variation on the theme is to have the bank customer speak the dollar amount or the name of the recipient—the key here is that the server (1) is fundamentally trying to match the customer to a recorded voice sample, not figure out who the customer is from the universe of all people and (2) the assumption is that given a bit of speech, malware can't mimic the person's speech saying something else. (This is actually the problem with reading the dollar amount—since the universe of numbers is small, it might be possible to capture and replay, while with CAPTCHAs the malware needs to fabricate what to say.)

Banking fraud has always been present, but has shifted in recent years towards online attacks. Malware authors develop software that runs in the victim's computer, silently performing banking transactions that transfer funds from the victim's account to accounts controlled by confederates. The problem is sufficiently severe that the American Bankers Association has recommended that small and medium businesses use a dedicated computer system for ACH (Automated Clearing House) transactions, to reduce the risk that malware introduced through email or web surfing can manipulate transactions. Older techniques for bank fraud relied on stealing passwords and using them later; using malware running in the victim's computer reduces the opportunity for detecting the attack since the transactions are performed by a legitimately authenticated customer from the customer's own computer.

Using money mules (frequently recruited by offering out-of-work people a share of the profits for transferring funds), the stolen proceeds are transferred offshore. This process requires an integrated system, including malware authors, methods to propagate the malware, individuals to set up bank accounts in target countries, money mules, etc. Cracking the overall system is a focus of law enforcement. Our goal in this paper is to prevent theft, even if malware has been introduced into the victim's computer, but with minimal disruption to the online banking process.

As disclosed herein, speech technologies may be used to provide safer financial transaction on potentially compromised computers. Our technique, which we call Out Of Band Voice Authorization for Transactions (OOBVAT), uses voice technology to combat malware operating in the victim's computer. OOBVAT relies on the ability to have users say a short sequence of words in response to certain transaction requests. We use speaker verification to ensure that the person making the request is the registered owner of the account, and speech recognition to determine whether they are requesting the transaction as received by the banking server.

The remainder of the paper describes: the threat model and how attacks operate; the state of the art in speech technologies, including current limitations; the usage model for OOBVAT; OOBVAT challenges; related work; applicability to other fields; and future research for OOBVAT.

There are currently security risks associated with online financial transactions. A significant fraction of personal computers are currently infected with malware of one form or another. We assume for purposes of this paper that the victim's computer has been compromised by malware, and that the attacker has the opportunity to install updated versions of the malware without the victim's cooperation or knowledge.

Given the assumption that the victim's computer is infected with malware, the attacker has several opportunities:
1. To steal data already present on the victim's computer, such as passwords stored in the browser password store.
2. To steal data in real time as it is processed, such as credit card numbers or usernames/passwords for banking sites.
3. To manipulate transactions in real time as they occur, such as to change the payee or amount for a bank or credit card transaction.

Of these, our goal with OOBVAT is to prevent the third.

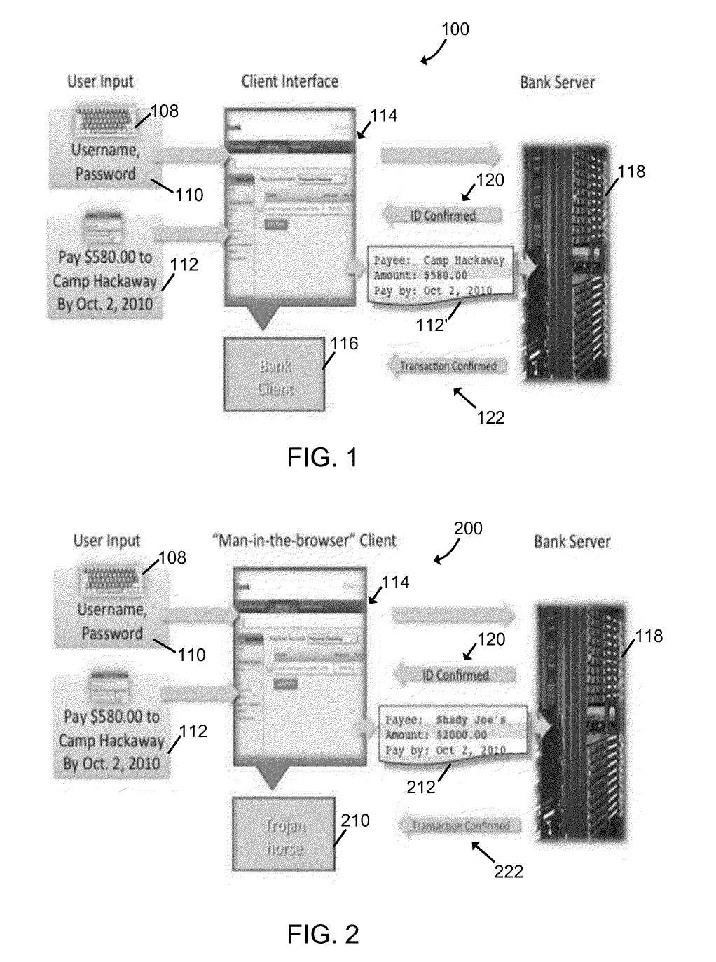

FIG. 1 shows a typical banking transaction 100 without malware involvement. The user logs in to a user computer 108 and enters user input 110 (e.g. a username and password), makes a transaction request 112 through a browser 114 of a bank client 116, which is sent as input 112′ to the server 118 for processing and confirmed 120, 122. As illustrated, the transaction request 112, 112′ contains an instruction “pay,” a dollar amount, “$580.00,” a payee identifier, “Camp Hackaway,” and a date, “Oct. 2, 2010.”

In this disclosure, we are focused on Man In The Browser (MITM) attacks, as shown in FIG. 2. In a MITM attack 200, the malware 210 (e.g., a “Trojan Horse”) running inside the browser 114 replaces the user's request 112′, in this case to pay $580.00 to Camp Hackaway, with a new transaction 212, to pay $2000.00 to Shady Joe's. Because the malware 210 is running inside the victim's browser 114, she is unable to see that the transaction being performed is not what she had intended, and the server 118 confirms the transaction 222. In some cases, the malware 210 may also adjust other elements of the user interaction with the web site accessed via the browser 114 of the bank client 116, for example to remove references to the fraudulent transaction 212 from a bank account statement, or to adjust the balance so the victim cannot tell that the money has been removed from her account.

State-of-the-art automatic speech recognition (ASR) is based on the statistical approach of the Bayes decision rule, using two kinds of stochastic models: the acoustic model and the language model. The acoustic model captures the acoustic/phonetic properties of speech and provides the probability of the observed acoustic signal given a hypothesized word sequence. Input speech for this model is parameterized into frame-level acoustic vectors, which are used as features in statistical modeling (e.g., Hidden Markov Modeling) of sub-word units, generally phonemes, mapped from words via a pronunciation lexicon. Speaker/environment normalization and adaptation, across-word modeling, and discriminative modeling are employed in state-of-the-art ASR systems to make recognition robust to changing speakers/environments as well as different phonetic contexts. The language model captures the linguistic properties of the language and provides the a-priori probability of a word sequence. Given these models, during decoding/search, competing sentence hypotheses are generated and scored, and sentence hypothesis with the best score is searched via dynamic programming The efficiency of the search process is increased by pruning unlikely hypotheses as early as possible during dynamic programming without affecting the recognition performance State-of-the-art ASR systems are optimized for the Word Error Rate (WER) metric.

The standard technique for doing speaker verification is called GMM-UBM. In this approach, first a Gaussian mixture model (GMM) is trained on speech from as many speakers as possible, providing a “universal background model” of speech (the UBM). Then, for each speaker to be enrolled in the system, a GMM is adapted (typically using maximum a posteriori (MAP) adaptation technique) from the UBM by using training data for that speaker. The background GMM typically has 1,024 Gaussian components. These statistical models use spectral features, called standard Mel-frequency cepstral coefficients (MFCCs), as inputs. These are short term (typically 25 msec.) speech segments which have undergone a spectral transformation process to reduce the dimensionality while preserving the relevant speaker information. Once the speaker-specific models are created, verification may be done. For a given speaker model, two types of testing data are used—one from other samples of the same speaker (called true trials) and the other using samples from other speakers (called impostor trials). In this paradigm, the goal is to make a decision on whether to accept or reject the trial samples as being from the same speaker as the one in the training model. If an impostor trial is accepted, it is called a false acceptance error. If a true trial is rejected, it is called a false reject error. A common way of optimizing the system is to minimize the equal error rate (EER) [symbol] the point at which the percent of false acceptance errors and of false reject errors are equal. NIST frequently conducts the Speaker Recognition Evaluation (SRE) which includes competitors from many countries. The best systems achieved EERs lower than 1% on telephone conversations, however this number is much higher when using far-field and mismatched microphones.

OOBVAT's goal is to use speech technologies to ensure that the human, and not malware acting on the human's behalf, is making the transaction request. Specifically, our goal is not to improve user authentication, but rather to perform transaction verification.

When the user opens her bank account, she participates in an enrollment process, where her voice is recorded and patterns are stored in the bank's servers. We assume this occurs in person with a bank employee to avoid the recursion problem of knowing that the person opening an account online is truly the person who owns the account.

Once the user is enrolled, her online transactions are subject to verification using OOBVAT. We do not expect that every transaction will be verified—for example, known payees (such as the electric company or mortgage company) may be considered pre-approved by the bank presuming that the details such as account number and the dollar amount are within norms for the customer. OOBVAT comes into play when the banking server sees an anomalous transaction—perhaps to a previously unknown payee, or with a different recipient account number than usual, or for an atypical amount for that payee.

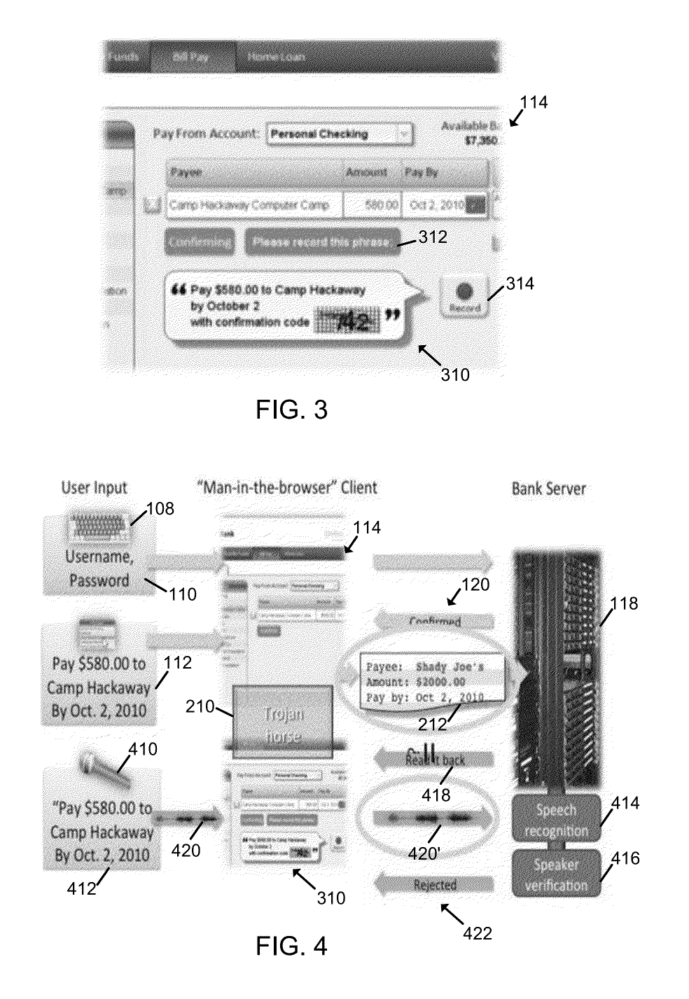

When anomalous transactions are detected, the bank server 118 presents a challenge 310 to the user, as seen in FIG. 3. The browser 114 displays a message 312 instructing the user to “please record this phrase,” and a “record” button 314. In the illustrative challenge 310, the user must speak the transaction amount, payee, date, and a confirmation code (presented in FIG. 3 as a CAPTCHA).

The server 118 prompts the user 418 to read back the challenge 310, and the audio 412 spoken by the user is recorded by a microphone 410 at the user's computer 108 and the recorded audio 420, 420′ is sent to the server 118, which performs two validations 422, as seen in FIG. 4.
1. Is the recorded audio 420, 420′ the voice of an authorized user of the account? Speaker verification 416 validates with high confidence that the voice 420, 420′ belongs to the authorized user. Substituting a different person's voice can be detected and rejected. Having several seconds of voice reduces the potential for false positives (i.e., validating an unauthorized user) as well as false negatives (i.e., refusing to verify an authorized user).
2. Is the transaction 212 what the user intended? Speech recognition 414 allows us to verify that the payee and amount are who and what the user intended. The date is included to reduce the risk of malware playing back a previous transaction authorization, as is the CAPTCHA.

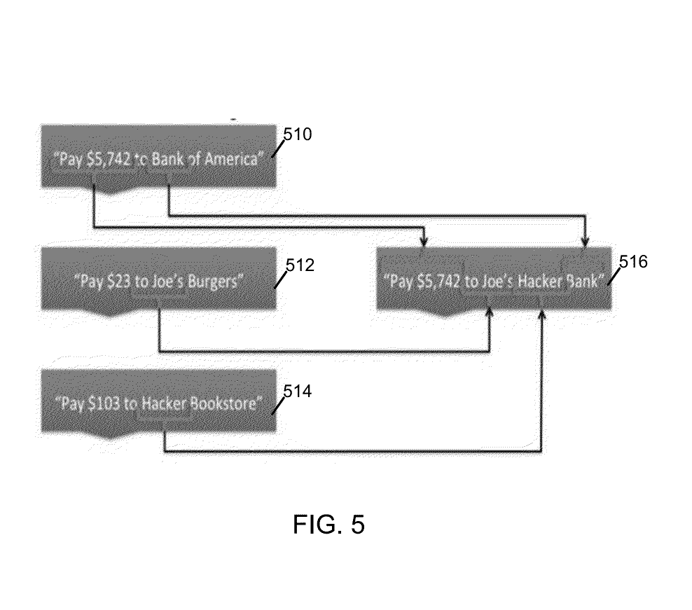

As noted with the date and CAPTCHA, one of the risks is that a previous speech recording will be played back. Another risk is that malware will paste together snippets of speech 510, 512, 514 from different transactions to create a new authorization 516, as seen in FIG. 5. Surprisingly, speech research has not focused on preventing such attacks. Use of the CAPTCHA is intended to reduce this risk. Even with CAPTCHA solving techniques, malware would need to synthesize individual the user's pronunciation of letters and digits to authorize the transaction.

In one example, a user must first enroll to establish a baseline for her speech. This is a relatively painless process, requiring that the user speak for approximately 120 seconds. Ideally, the speech training will include text likely to occur in transaction approvals, such as names of common recipients, numbers, and letters. However, modern speech recognition technology can operate successfully even without complete training

A limitation today is speech recognition of new payees. For example, if the user asks to make a transfer to a company with a synthetic name, speech recognition may have difficulty determining that the name typed as the recipient truly matches the spoken name. The risk of accepting a name without speech recognition is that malware could be performing a substitution unknown to the user. We assume that malware is present in the user's computer. An approach is for the speech recognition system to generate many possible patterns that would correspond to the previously unknown payee, and see if the user's spoken name corresponds to any of them. If it does not, then an out-of-band system (e.g., using a telephone enrollment scheme) may be necessary.

As noted in the previous section, a MITM attacker can piece together previously recorded speech samples to create new transaction verification. Nonetheless, OOBVAT will significantly increase the bar for attackers, and hence provide improved protection compared to the status quo.

Current speech technology is affected by the differences in microphones. Hence, there may be mismatches between microphones used during training in a bank compared to the microphone used at home, or between use with the user's business computer compared to the home computer. A countermeasure would be to have the bank provide the customer with a one-time authorization for enrollment which could be performed from the user's home computer. This increases the risk of malware interfering with the enrollment, but could be counterbalanced by having the user verify the speech recording using a secondary method such as a telephone.

OOBVAT was inspired by SpeakUp, which is a paper design that uses speaker verification and speech recognition to allow voting from a malware-infected computer. While we support the concept, we believe that the names of candidates are too short to perform speaker verification (which typically takes a few seconds), and speech recognition will be difficult for candidate names which may not be in the vocabulary of a speech recognition system.

We do not know if there has been any work in the financial services industry to use speaker verification and speech recognition for transaction authorization. There is a long history of using speech as a biometric for user authentication, but we are unaware of prior use for transaction authorization, which is more critical in today's threat environment.

The concepts behind OOBVAT are applicable to other types of transactions besides banking and similar financial needs. For example, the same approach could be used for electronic commerce, where the user confirms her transaction by speaking the name of the product and the price to be paid.

Such a technique could also be used for medical transaction authorization.

A future research area for OOBVAT is usability testing—can a system using OOBVAT be understandable to users, and will they accept the additional inconvenience of voice authorization? Acceptance in the commercial market may require some incentives by banks to encourage users to perform the voice validation, perhaps by limiting liability for those users who perform the validation but not for users who refuse to participate.

A related research area is determining guidelines for what transactions can be approved without voice verification, and which require the extra step. This will require working with financial institutions to understand their existing transaction anomaly detection systems.

In the area of improved speech technology, the ability to detect pieced-together speech segments is important over the long term, as we expect that attackers will respond to OOBVAT by trying to synthesize verification speech strings.

1. (canceled)

2. A method for allowing a user of an online system to authorize transactions from untrusted computer systems, the method comprising, with the online system:
receiving a transaction request of the user, the transaction request to accomplish an online transaction, the transaction request comprising financial information, and in response to the transaction request:
presenting a series of tests to the user, each of the tests comprising text that is human-intelligible but not intelligible by computers;
creating a recording of the user's voice speaking one of the tests of the series of tests;
recognizing the one of the tests spoken by the user in the recording as being one of the presented series of tests;
verifying the recording by matching the recording to a known sample of the user's voice; and
rejecting the transaction request if the one of the tests spoken by the user is not recognized as being one of the presented series of tests and/or if the recording does not match the known sample of the user's voice.

3. The method of claim 2, wherein presenting the series of tests comprises presenting a plurality of different Completely Automated Public Turing tests to tell Computers and Humans Apart (CAPTCHAs).

4. The method of claim 2, comprising performing automated speech recognition on the recording to recognize the one of the tests spoken by the user in the recording, and comparing the recognized one of the tests spoken by the user to the presented series of tests.

5. The method of claim 2, wherein the creating a recording comprises recording the user's voice speaking at least a portion of the financial information of the transaction request.

6. The method of claim 5, comprising performing automated speech recognition on the recording including the spoken financial information to verify the transaction request.

7. The method of claim 5, wherein the spoken financial information comprises an amount of money and a payee, and the method comprises verifying the amount or the payee using the automated speech recognition.

8. The method of claim 6, wherein the spoken financial information identifies a payee, and the method comprises generating a plurality of patterns with the automated speech recognition system, each of the plurality of patterns possibly corresponding to the payee, and determining whether a portion of the recording including the payee corresponds to any of the patterns.

9. The method of claim 6, comprising, with the automated speech recognition system, generating a plurality of hypotheses, each of the plurality of hypotheses possibly corresponding to at least a portion of the recording, and using at least one of the hypotheses to recognize at least a portion of the spoken financial information.

10. The method of claim 2, wherein the financial information comprises an amount of money, a payee, a transaction date, and/or a financial account identifier, and the method comprises determining to present the series of tests to the user based on the amount of money, the payee, the transaction date, and/or the financial account identifier.

11. The method of claim 10, comprising determining if the amount of money exceeds a defined amount and presenting the series of tests to the user in response to determining that the amount of money exceeds the defined amount.

12. The method of claim 10, comprising determining if the payee is a payee that the user has not previously transacted with, and presenting the series of tests to the user in response to determining that the payee is a payee that the user has not previously transacted with.

13. The method of claim 2, comprising creating the known sample of the user's voice by recording the user's speech prior to the transaction request.

14. The method of claim 13, comprising recording the known sample of the user's speech during a user registration process.

15. The method of claim 2, comprising performing out-of-band voice authentication to determine if the comparison of the recording to the known sample is successful.

16. The method of claim 2, comprising creating a user-specific speaker model using training data for the user, and performing speaker verification of the recording with the user-specific speaker model.

17. The method of claim 16, wherein creating the user-specific speaker model comprises adapting a Gaussian mixture model using training data of the user.

18. The method of claim 16, wherein the user-specific speaker model comprises speech segments from the user and speech segments from other speakers.

19. The method of claim 18, comprising applying a spectral transformation process to the speech segments to preserve relevant speaker information and reduce dimensionality.

20. An online system comprising:
a microphone, the microphone configured to receive speech spoken by a user of the online system;
a speaker verification subsystem configured to, in response to a transaction request initiated by the user, the transaction request involving financial information:
present a series of tests to the user, each of the tests comprising text that is human-intelligible but not intelligible by computers;
create a recording of the user's voice speaking one of the tests of the series of tests;
determine the one of the tests spoken by the user in the recording; and
match the recording to a previously-made recording of the user's voice to verify that the recording is of the user's voice; and
a speech recognition subsystem configured to verify the recorded one of the tests spoken by the user as being one of the presented series of tests.

21. The online system of claim 20, comprising a user computer and a server, wherein the user computer creates the recording and the server verifies the recording of the user's voice and verifies the spoken test.

22. The online system of claim 21, wherein the server detects transaction requests involving large or anomalous financial transactions and in response to detecting a large or anomalous financial transaction, presents a challenge to the user to speak the financial information and one of the tests of the series of tests.

23. The online system of claim 21, wherein the user computer interacts with the server through a client interface including a browser.
